(19) United States
(12) Patent Application Publication
(10) Pub. No.: US 2008/0148791 A1
(43) Pub. Date: Jun. 26, 2008

(54) Security lock for doors that open inwardly

(76) Inventor: Sam A. Morrison, Lynchburg, VA (US)

Correspondence Address: WILLIAM B RITCHIE;LAW OFICE OF WILLIAM B. RITCHIE, 413 NOBLE FAIRE DRIVE, SUN CITY CENTER, FL, 33573, US

(21) Appl. No.: 12/002,776

(22) Filed: Dec. 18, 2007

Related U.S. Application Data
(60) Provisional application No. 60/876,722, filed on Dec. 21, 2006.

(51) Int. Cl. E05B 65/06

(52) U.S. Cl. 70/101

(57) ABSTRACT

A portable security lock for an inwardly opening door. Matching short and long locking blocks are held together by screws or other suitable fasteners. A locking bar having an insertion section that can be placed in the strike plate of the door jam is provided. The locking bar further has a row of teeth that face the insertion section. A pivoting arm, connected to the attached matching short and long locking blocks is provided. The pivoting arm has a locked and unlocked position and a series of teeth that mesh the teeth of the locking bar. When the locking arm is fully engaged against the locking bar via the respective sets of teeth, the locking bar is held firmly in position.

This application claims benefit under 37 CFR 119(e) of U.S. Patent Application Ser. No. 60/876,722 filed on Dec. 21, 2006.

### FIELD OF THE INVENTION

This invention relates to door locks, namely, keyless, removable locks for inwardly opening doors.

### BACKGROUND OF THE INVENTION

Door locks have been around probably since man invented the door. Some of the earlier versions had heavy metal lock boxes that were unlocked with a “skeleton key”, so named for its shape which resembles part of a skeleton.

As doors, locks and door jams (that structure from which the door is hung so that it may pivot) improved, the use of the door extended beyond merely providing an entrance and exit to a dwelling.

Internal doors such as bathroom, hotel/motel, bedroom or bathrooms in the home, public rest rooms, cruise ships etc. most commonly open inwardly toward the space that the door is providing access. Such doors in homes are typically bathroom and bedroom doors that may have no security locks or are limited to locking with a push button lock set. Hotel/motel or cruise ship doors usually have a security lock usually associated with the door knob or handle used to open the doors. These doors frequently provide additional security consisting of a short chain with one end attached to the door and another end attached to the jam. Theoretically, an inhabitant of the room could open the door slightly to view a person on the outside to determine whether the door should be opened fully so that the person could be allowed to enter. However, such an arrangement is easily defeated by an intruder who can easily break the chain to gain entry.

Whether it is used to prevent crimes against the occupants of the room, or to ensure the privacy of a person in a bathroom, there is a need for an easily attachable, keyless, security lock that cannot be defeated by an unauthorized party trying to gain access to the room while the occupant(s) are located therein. There is no security lock in the prior art that meets this objective.

### SUMMARY OF THE INVENTION

It is an aspect of the invention to provide a security lock for inwardly opening doors that can be easily attached by the occupants of the room.

It is another aspect of the invention to provide a security lock that can be molded from a plastic that is extremely durable yet inexpensive to produce.

It is still another aspect of the invention to provide a security lock that can be used with either left handed or right handed inwardly opening doors.

Another aspect of the invention is to provide a security lock that can be used with most such doors noted above.

It is another aspect of the invention to provide a security lock that can be taken with the user when that person is traveling to a distant location.

Finally, it is another aspect of the invention to provide a security lock that does not require a key, which will make it extremely difficult to open the door from outside, and is easily attachable and removable.

### BRIEF DESCRIPTION OF THE DRAWINGS

FIG. 1 is an isometric view of the security lock in place on a typical door in accordance with the invention.

FIG. 2 is an isometric view of an alternative embodiment of the security lock in place on a typical door.

FIG. 3 is an isometric view of the preferred embodiment with the locking wedge in place.

FIG. 4 is a top view of the locking bar.

FIG. 5 is a side view of the locking bar.

FIG. 6 is an isometric view of the locking bar.

FIG. 7 is an isometric view of the locking bar showing how the locking bar is moved into position within the door's strike plate.

FIG. 8 is an isometric view of the locking bar in place on the door's strike plate.

FIG. 9A is a top view of the two sections of the locking blocks attached together in the preferred embodiment.

FIG. 9B is a top view of an alternative embodiment showing two sections of the locking blocks attached together.

FIG. 10 is a side view of the long locking block.

FIG. 11 is a side view of the short locking block.

FIG. 12 is a top view of the locking block indicating the difference in length from the long block to the short block.

FIG. 13A is a side view of the preferred embodiment with the short locking block in place to show attachment to the locking bar.

FIG. 13B is an alternative embodiment showing a side view of the locking blocks with the locking bar inserted therein.

FIG. 14 is the preferred embodiment with the short locking block removed in order to show the locking mechanism.

FIG. 15 is still another alternative embodiment with the short locking block removed in order to show a different locking mechanism.

FIG. 16 is a side view of the anchoring wedge.

FIG. 17 is a top view of the anchoring wedge.

FIG. 18 is a bottom view of the anchoring wedge.

FIG. 19 is an isometric view of the anchoring wedge.

### DETAILED DESCRIPTION OF THE INVENTION

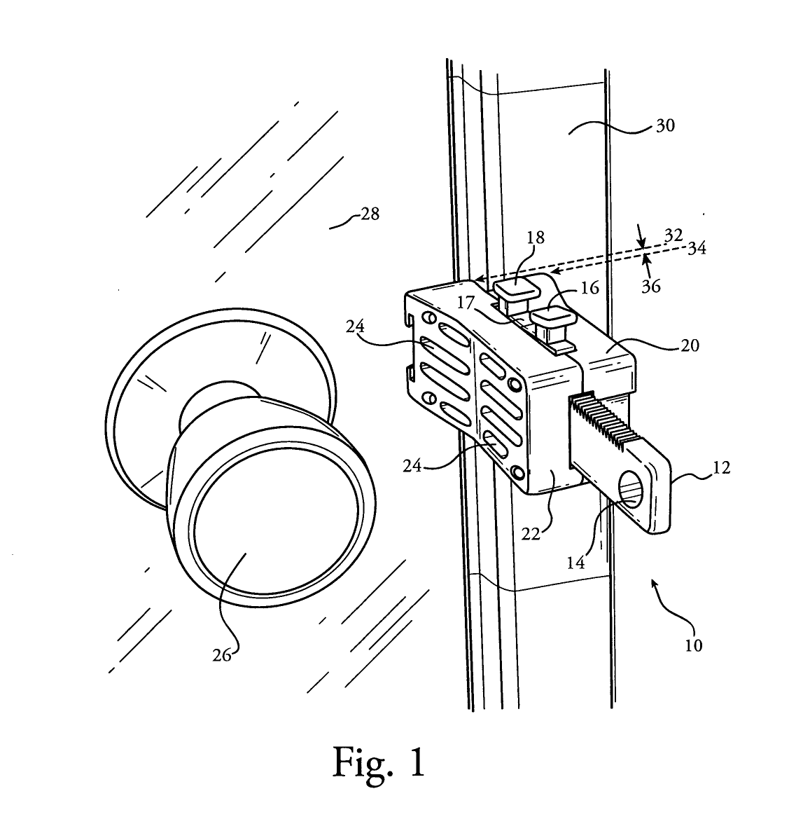

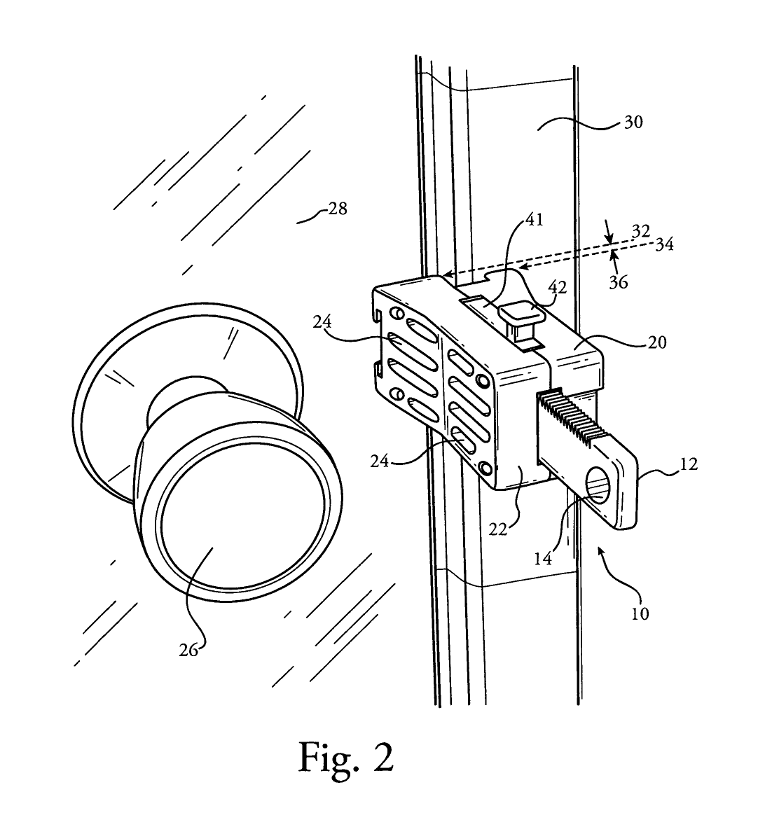

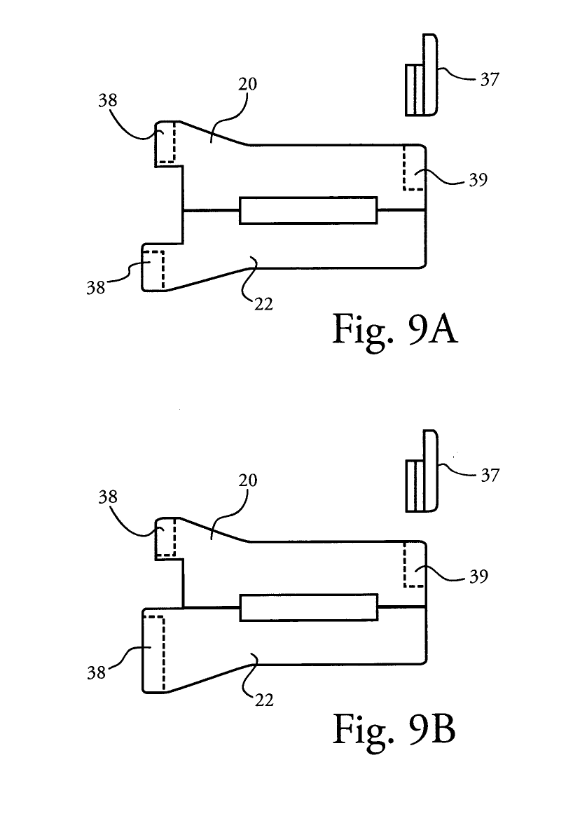

Invention 10 is a security lock for inwardly opening doors, either left or right handed. As shown in FIG. 1, it is being used on a generic right handed door 28. Door 28 is opened by knob 26. This particular lockset is shown without a locking button; for example, one that would be used to prevent someone else from walking into a bathroom when it was occupied or other security measures such as a keyed lock set. Note that the embodiment shown has the front of the long locking block 22 rests securely on the surface of door 28 along plane 32, while the short locking block 20 rests securely on the surface of the door jam 30 along plane 34. Measurement 36 is between planes 32 and 34. As shown below in FIG. 9B of an alternative embodiment, insert 37 can be used to adjust variations that may occur in measurement 36.

Locking bar 12 is positioned between locking blocks 20 and 22 and urges invention 10 firmly against door 28 and jam 30 via rocking locking arm 17 that is activated using handles 16 and 18. Opening 14 is used merely to provide a means to hang invention 10 for display, for sale or for storage. Locking bar is preferably made of fiberglass material, as are the other parts of invention 10. In this manner, invention 10 can withstand 500 lbs. of pressure without breaking.

Recesses 24 are provided in both the long block 22 and the short block 20 to reduce the amount of plastic required for molding yet not reduce the strength of the apparatus.

The inventor has found that once the security lock 10 is firmly in place on door 28, the amount of force required to open it is much greater than can be provided by a typical adult male, even a very strong one. This required force far exceeds what is necessary to break a chain lock and defeats someone who may have an unauthorized key for doors having keyed entries.

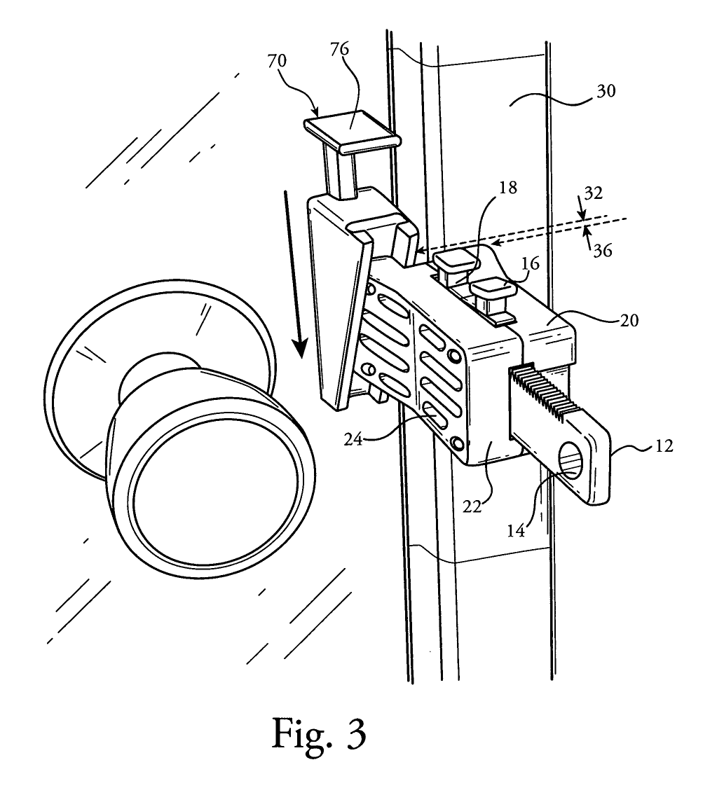

As shown in FIG. 3, the preferred embodiment's anchoring wedge 70 is firmly in place so that the differences between measurement 36 and 32 can be accommodated. Anchoring wedge 70 is thus able to accommodate different jam door configurations.

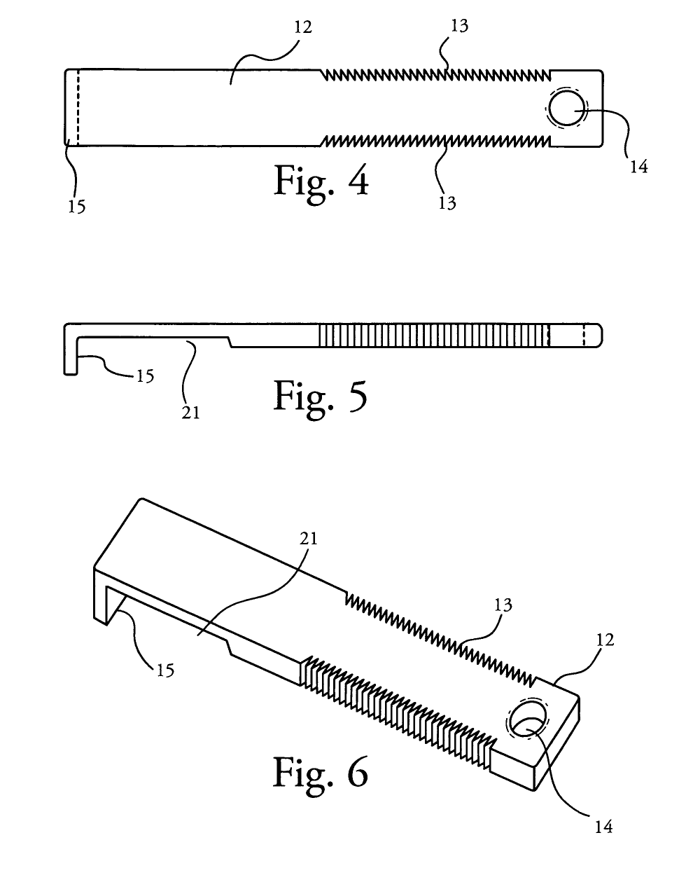

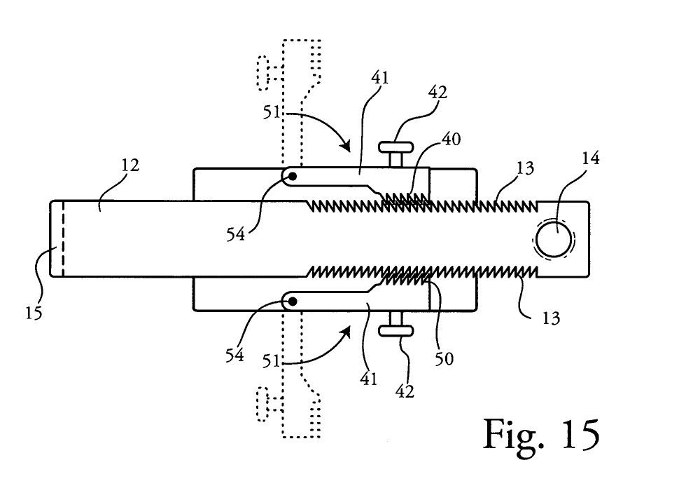

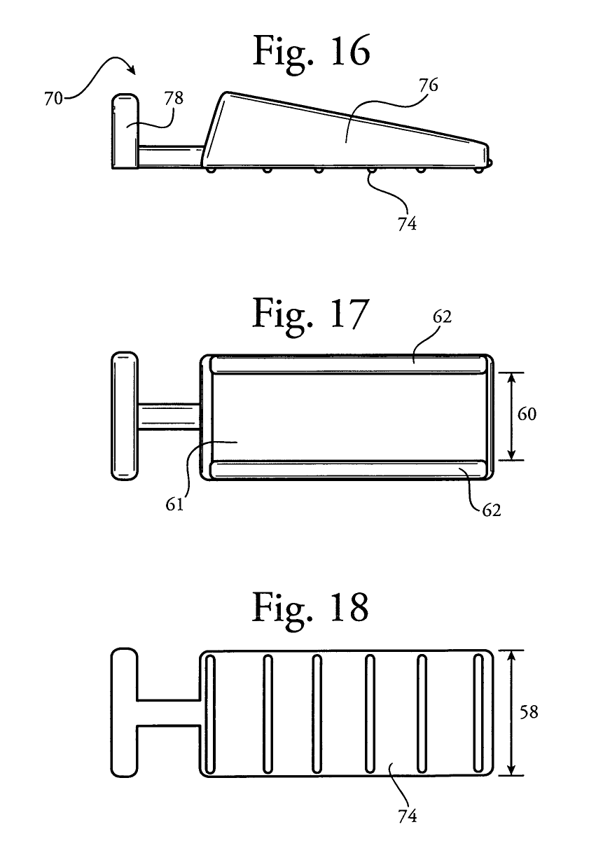

As shown in FIGS. 4 thru 7, a detailed view of the locking bar 12 is provided. Preferably, this part is molded of the same fiberglass material used for blocks 20,22. The backward facing teeth 13 are designed to engage meshing teeth 40 that are provided on rocking locking arm 17 so that the two blocks 22, 20 are pulled tightly against door 28 and jam 30 via blocks 22, 20 respectively. (See FIG. 14) Also, indent 21 is made thinner than the remaining section of locking bar 12 so that locking bar 12 can be inserted between the space between door 28 and jam 30. This distance 34 is identified in FIG. 1.

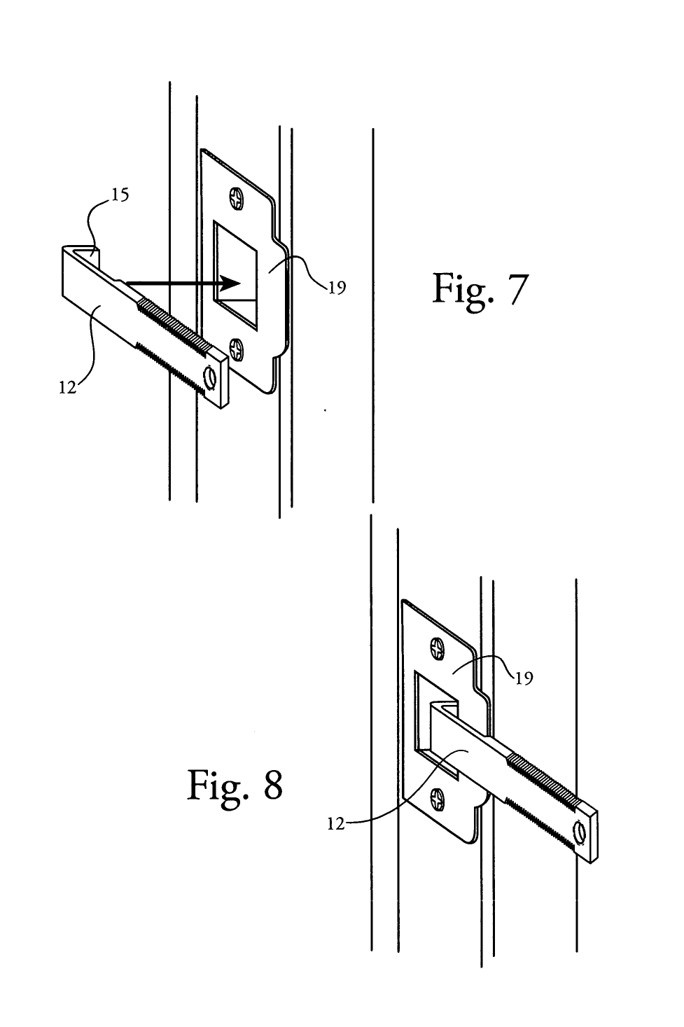

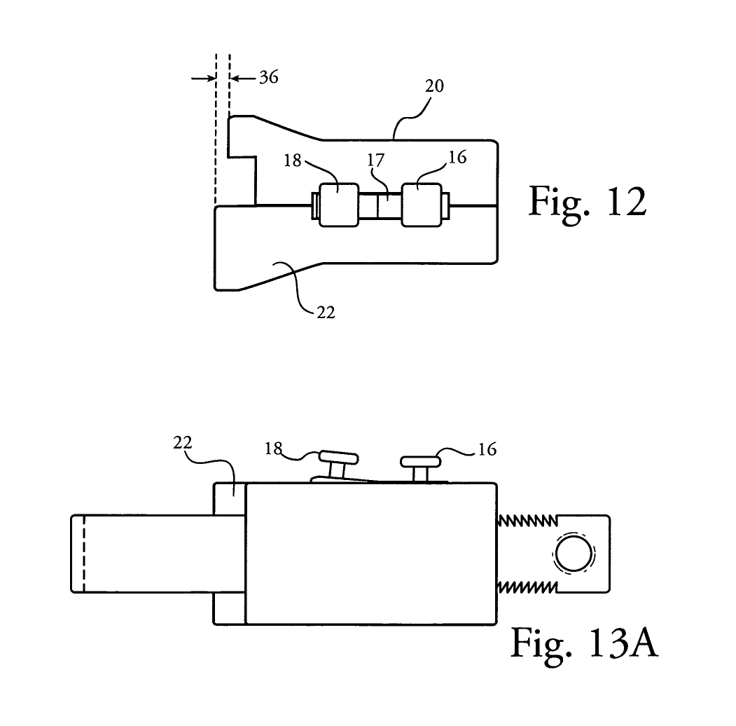

As shown in FIGS. 7 and 8, locking bar 12 with its insertion bar 15 is merely inserted in the opening in striker plate 19. This provides an anchoring for locking bar 12 to pull against once blocks 20, 22 are placed on door 28 and jam 30. As shown in FIG. 12, activating the locking arm 17 causes the blocks to be pulled tightly against the door, wherein opening door 28 becomes impossible unless sufficient force is applied to break insertion section 15 (FIGS. 4 thru 6) of locking bar 12. This amount of force is well beyond the strength capabilities of most people. The use of a pry bar (not shown) would probably be needed to accomplish a break in. Even if the security lock 10 were defeated, the amount of time and noise would be sufficient to provide the occupant with sufficient time to either escape via another exit or call the police.

FIG. 9A is the preferred embodiment of the top view of the two sections of locking blocks 20, 22 that are locked together. Note that section 38 prime is rigidly attached to locking block 20. Anchoring wedge 70 is not shown in this view.

FIG. 9B is an top view of blocks 20, 22 showing the alternative extension block 37 that may be placed when in use in slots 38 or merely being stored in slot 39.

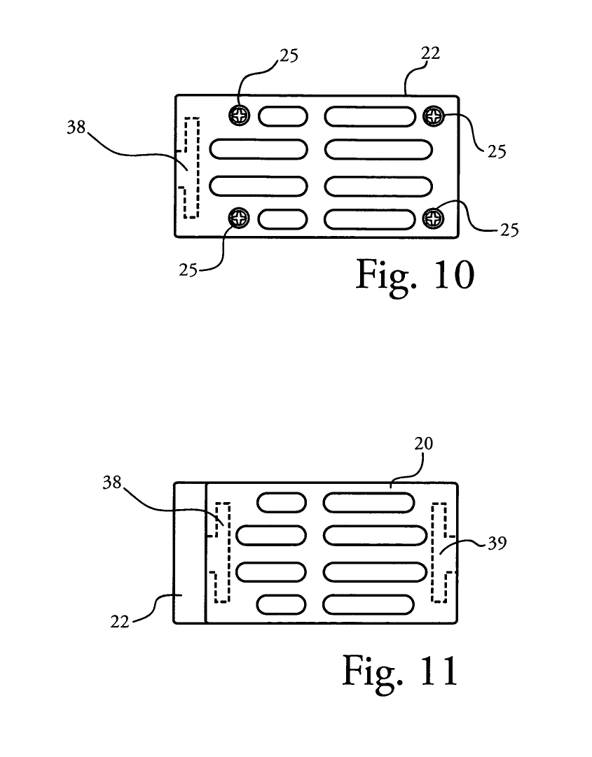

FIG. 10 provides a side view of long block 22 showing screws 25 which fasten the two blocks together. Also, slot 38 is shown which can accommodate extension block 37 to provide an even greater distance 36 for those cases where the difference between surface plane 32 on door 28 and surface plane 34 on jam 30 is even greater.

FIG. 11 is a side view of short block 20 showing slot 39 for storage of extension block 37 or for the door situations where plane 32 and 36 are in the same plane as noted in FIG. 10.

FIG. 12 is a top view of the locking blocks indicating the difference in length between the long block and the short block.

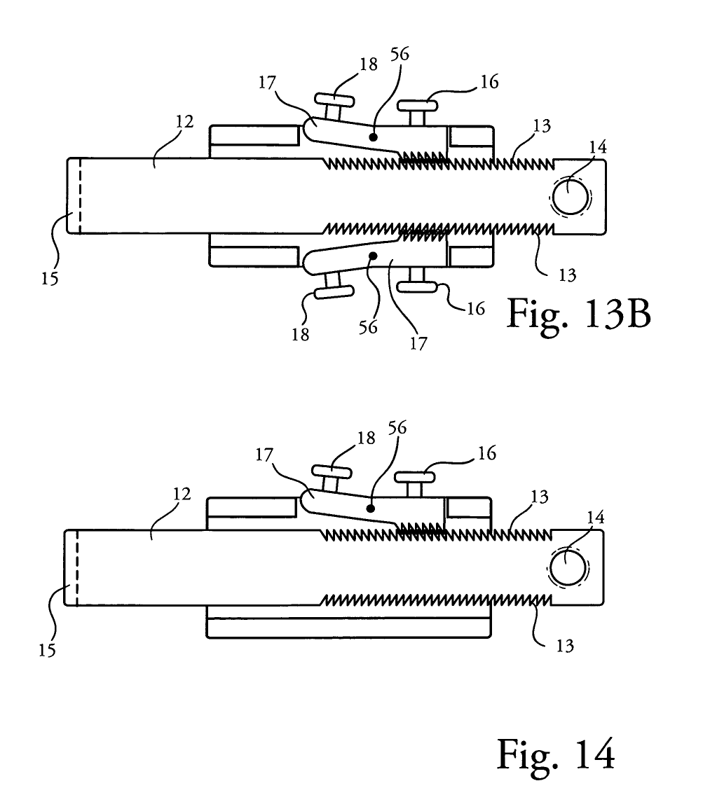

FIG. 13A is a side view of the preferred embodiment with the short locking block removed so as to show how the locking block is releasably attached to the bar.

FIG. 13B is an alternative embodiment showing a side view of the locking blocks 20, 22 with the locking bar 12 inserted therein.

FIG. 14 is the preferred embodiment with short locking block 20 removed to show the locking mechanism.

FIG. 15 is still another embodiment with the short locking block 20 removed to show the locking mechanism.

Note that all of these mechanisms show the locking bar being urged against security locking teeth 10 so that locking bar 12 is firmly urged against door 28 and its door jam 30. Also, all of these locking arms have a rocking pin/integrally molded pin 56 to provide a locked and unlocked position when the appropriate handles 18 and 16 are activated. For example, as shown in FIG. 14, an identical rocking locking arm 17 and its handles 16, 18 can pivot on integral molded pin 56. A corresponding locking arm 17 (not shown) can be situated opposite one another with sufficient distance between them so locking bar 12 may be placed between them. When teeth 13 and 40 are fully engaged, locking bar 12 is tightly held. When the respective rocking locking arms 17 are pivoted away from the teeth as shown, locking bar 12 is easily removed from the two blocks 20, 22. Note that pins 56 are molded into long locking block 22 with a corresponding indent being molded into the short locking block 20 so that the two blocks 20, 22 are properly aligned. In this case, to switch from left handed to right handed doors, or vice versa, a user merely places the insertion bar 15 into the opening of striker plate 19 and flips the locking blocks 20, 22 over.

As illustrated in FIG. 15, still an alternative locking arrangement is provided. FIG. 15 is also a detailed side view of long locking block 22 with short locking block 20 removed to show how locking bar 12 urges the security lock 10 against a door and its door jam. As shown, pivoting locking arm 41 has a set of teeth 40 which mesh with teeth 13 on the locking bar 12. Each pivoting locking arm 41 has a handle 42. When handle 42 is pushed down, pivoting locking arm's 41 teeth 40 and 50 engage teeth 13. Pivoting locking arm 41 and its handle are able to pivot on integral molded pin 54 in the direction of radius 50. Correspondingly, an identical arm 41, handle 42 and an integral molded pin 54, is situated opposite, providing sufficient distance is between them so locking bar 12 may be placed between them. When teeth 13 and 40 are fully engaged, locking bar 12 is tightly held. When the respective arms 41 are pivoted away from the teeth as shown, locking bar 12 is easily removed from the two blocks 20, 22. Note that only half of pins 54 and 50 are molded into long locking block 22 with the corresponding half being molded into the short locking block 20. To switch from left handed to right handed doors, or vice versa, a user merely places the insertion bar 15 into the opening of striker plate 19 and flips the locking blocks 20, 22 over and then pushes the locking arms 41 via handles 42.

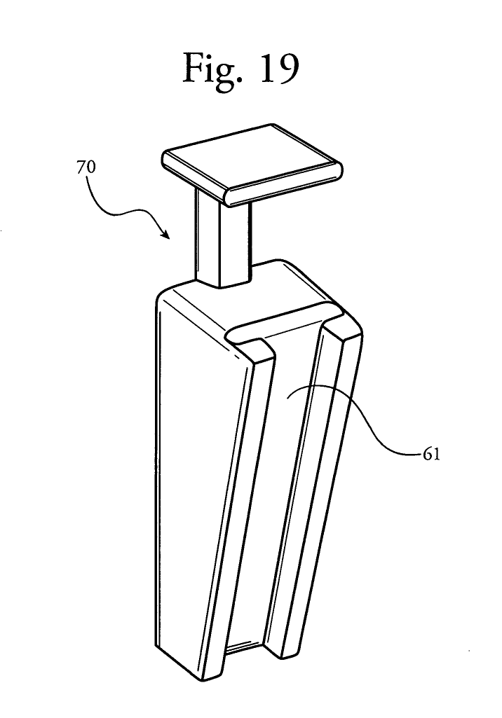

As shown in FIG. 3, which is the preferred embodiment of the invention, anchoring wedge 50 is positioned against door 28 to make up the difference in distance between the door jam 30 and door surface 28. This works by attaching to the long arm 22 of the long locking block 22 using slot 61 (See detail of this slot in FIGS. 17 and 19.)

To install the unit, insertion bar 15 is placed in strike plate 19 as shown in FIGS. 7 and 8. Locking bar 12 is then held in position while locking blocks 20, 22 are slid over the locking bar 12 as shown in FIG. 3. To complete the installation, the invention 10 is pushed tightly against the door and jam with the appropriate locking button 16 or 18 pushed downward on handle 76 of anchoring wedge 70 and anchoring wedge 70 is slid down against door 28 along sides 62 in the direction as shown. Note that the difference in dimension 60 and sides 62 correspond to the thickness of the ends of blocks 20, 22. As noted above, anchoring wedge 70 is held onto long locking block 22 via slot 61 engaging the end of long locking block 22.

There are no critical dimensions in invention 10. However, the thickness of locking bar 12 in indent 21 must be selected to fit within the space between door 28 and door jam 30 and have a width that does not exceed the opening provided by striker plate 19. In the preferred embodiment, the thickness of locking bar 12 is approximately ⅛ of an inch and the width is about ¾ of an inch. The selection of the material that is used is also not critical but it must be easily moldable. The material must have sufficient durability to prevent breakage if the security lock 10 is being forced open when it is in the locked position. As noted above, fiberglass is preferred because of its superior strength and low cost.

Although the present invention has been described with reference to certain preferred embodiments thereof, other versions are readily apparent to those of ordinary skill in the preferred embodiments contained therein.

What is claimed is:

1. A portable security lock for an inwardly opening door comprising:
matching short and long locking blocks that are held together by screws or other suitable fasteners;
a locking bar having an insertion section that can be placed in the strike plate of the door jam wherein said locking bar further having a row of teeth that face said insertion section;
a pivoting arm, connected to said attached matching short and long locking blocks, wherein said pivoting arm has a locked and unlocked position and a series of teeth that mesh with said teeth of said locking bar such that when/the locking arm is fully engaged against said locking bar via said respective sets of teeth, said locking bar is held firmly in position.

2. The portable security lock of claim 1 further comprising;
an anchoring wedge that slides between said door and said attached locking blocks with said locking bar in place such that said lock is tightly held in position against the door and the jam.

3. The portable security lock of claim 1 wherein said locking bar further comprises a second set of teeth on opposing edges of said locking bar.

4. The portable security lock of claim 1 wherein said locking bar further comprises and opening for hanging up said lock.

5. The portable security lock of claim 1 wherein one of said locking blocks is longer than the other one.

6. The portable security lock of claim 1 wherein said locking blocks have a plurality of recesses that reduce the amount of material needed for molding said blocks.

7. The portable security lock of claim 2 wherein said anchoring wedge has a slot that is adapted to fit a corresponding attachment section in one of said locking blocks.

8. The portable security lock of claim 2 wherein said anchoring wedge further comprises a plurality of sliding members located on a surface of said anchoring wedge so that said anchoring wedge may be easily slid against the door while attached to said attachment section.

9. The portable security lock of claim 1 wherein said pivoting arm further comprises a radius end and an opposing pivoting end such that the two ends are positioned along said pivoting arm and wherein said pivot point is positioned adjacent to said pivoting end and said set of teeth is positioned adjacent to the radius end.
